(19) United States
(12) Patent Application Publication
(10) Pub. No.: US 2004/0215630 A1
(43) Pub. Date: Oct. 28, 2004

(54) Hierarchical service management system

(75) Inventors: Pankaj Parekh, Fremont, CA (US); Sandeep Gupta, New Delhi (IN); Vijay Mamtani, New Delhi (IN); Atul Jain, Noida (IN); Sanjay Kumar Agarwal, Noida (IN)

Correspondence Address: William L. Botjer, PO Box 478, Center Moriches, NY, 11934, US

(73) Assignee: iPolicy Networks, Inc., Fremont, CA

(21) Appl. No.: 10/423,794

(22) Filed: Apr. 25, 2003

(51) Int. Cl. G06F 7/00

(52) U.S. Cl. 707/100

(57) ABSTRACT

The present invention provides a system, method and computer program product for managing customers in a hierarchical manner. The customer hierarchy comprises a root service provider (RSP), tiered service providers (TSPs) and end customers. The present invention enables the governing of the customers by a large service provider by providing an ability to make smaller service providers as customers and managing their resources. The smaller service provider, in turn, can have its own customers. The smaller service provider governs these customers without interference from the service providers above it in the hierarchy. The customers are governed by policies. A policy is a set of rules laid down by the service provider to control the customers. The present invention also enables the service provider to implement different policies on different customers and change the policy for a customer without affecting other customers.

### BACKGROUND

The present invention relates to a service management system. In particular, the present invention relates to the development of a service management system that allows a service provider to create and manage hierarchical administrative domains. Examples of hierarchical administrative domain are a network of service providers and customers, and an organization with central, regional and location offices.

With the advent of technology, the use of the Internet and similar communication means has increased tremendously. They provide a variety of services to the people, these services are provided by service providers over a network.

A service provider can have both individuals and organizations as its customers and provides various services to them. Some examples of such services are ‘Security Services’ and ‘Quality of Service’. ‘Security Services’ provide prevention of unauthorized breach in the network. Illegitimate users can change data, gain unauthorized access to data, destroy data, or make unauthorized use of computer resources of an organization. The organization needs to prevent such illegitimate users from accessing the data. Hence ‘Security Services’ are extremely important for the organizations. ‘Quality of Service’ provides a customer with the best available services based on the terms and conditions of their agreement. The service providers need to implement policies in order to make decisions regarding such services. A policy is a set of rules that govern the network traffic and is responsible for the management of the customers.

A service provider provides these services to its customers. In some cases the customers can be managed directly by the service provider and in other cases, the customers can be managed by smaller service providers, which in turn can be managed by larger service providers. To manage such a hierarchy of customers, there is a need for a hierarchical service management system rather than deploying different service management systems for each smaller service provider being managed by a large service provider.

Such a hierarchy of customers can exist between two service providers where one service provider sells its resource and services to another service provider and the second service provider sells the services to its own customers and manages its customers without interference from the first service provider. The second service provider can also customize services depending on the requirements of its customers.

Thus there is a need for a system and method that can implement such an arrangement of service providers. This would ease the load on the service provider and provide a way to manage large number of customers without difficulty.

### SUMMARY

The present invention provides a system and method for managing hierarchical administrative domains. In case of service providers, a customer hierarchy comprises a root service provider (RSP), tiered service providers (TSPs) and end customers. For the remainder of this document, the concept of the present invention will be explained by using the service provider administrative domains. To a person skilled in the art, it will be obvious that the present invention can be extended to other hierarchical administrative domains such as in a large enterprise environment.

In accordance with one aspect, the present invention provides a method for governing the customers and managing the resources. The customers are arranged in a hierarchical manner.

The hierarchy is based on the agreement between the customers and the immediate service provider. A customer can join the RSP or a TSP as an end customer or a TSP. If the customer joins the hierarchy as a TSP, the customers can create further customers and do not need approval from any of the TSPs, which are above it in the customer hierarchy, or from the RSP as long as the TSP has resources.

The services are governed by policies. A policy is a set of rules laid down by the service provider to control the services provided to the customers. The policies are enforced through a policy enforcement device. In order to know about alarming situations in the network such as security breach, the present invention determines whether there is a rule match between the flow of network traffic and a predefined rule. In case there is a match, then the customer and its service provider are informed.

In accordance with another aspect, the present invention also checks for a resource violation at the time of allocation of resources and informs the customer and its service provider in case there is a violation.

In accordance with yet another aspect, the present invention provides a service management system for managing the customers in a hierarchical manner. The system creates and manages the resources of the customers and governs them by implementing policies. The system checks for any resource violation by a customer and informs the customer and the customer's service provider in case there is a violation.

The system also determines whether there is a rule match of the flow of network traffic with a predefined rule. In case there is a match, the customer and its service provider are informed.

In accordance with a further aspect, the present invention provides a computer program product for managing customers in a hierarchical manner.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 shows a part of an exemplary customer hierarchy;

FIG. 2 is a block diagram of the hierarchical service management system with a user interface and a policy enforcement device, the user interface and the policy enforcement device being controlled by the service management system, in accordance with an embodiment of the present invention;

FIGS. 3a and 3b shows a flowchart illustrating a rule creation in the hierarchical service management system by a customer, in accordance with an embodiment of the present invention;

FIGS. 4a and 4b are tables depicting the policies enforced in a hierarchical manner, in accordance with an embodiment of the present invention;

FIG. 5 is a flowchart illustrating the functioning of an alarm when the flow of network traffic matches with a predefined rule, in accordance with an embodiment of the present invention;

FIG. 6 is a flowchart illustrating the resource allocation to the customers, in accordance with an embodiment of the present invention; and

FIG. 7 is a flowchart illustrating the change in the allocated resources to the customers, in accordance with an embodiment of the present invention.

### DESCRIPTION OF PREFERRED EMBODIMENTS

The present invention is a system and method for managing customers in a hierarchical manner. The customers are managed by a service management system. The management of customers involves enforcing the policies on the customers to govern the customers and to manage the resources of the customers. A policy is a set of rules that regulate the actions of a customer.

The present invention allows a tiered structure to exist among the customers and reduces the load on a Root Service Provider (RSP) by providing an ability to the RSP to allow a customer under the RSP to act as a Tiered Service Provider (TSP). This results in the formation of a customer hierarchy. The hierarchical structure of customers eases the management of a large number of customers.

The hierarchical management of the customers is done by allocating the resources to the customers in a hierarchical manner. The RSP and the TSPs allocate resources to the immediate customers under them. The immediate customers of a service provider are the customers that are one level below the service provider in the customer hierarchy.

A service provider needs to enforce rules for providing various services to its customers. The hierarchical service management system ensures that the rules can be enforced in a hierarchical fashion and results in the hierarchical management of customers. The RSP and the TSPs enforce the policies containing these rules for the immediate customers under them. The policies are enforced through a policy enforcement device. Enforcement of these policies results in providing the various services such as security services to the customers. The hierarchical service management system supports customer isolation and controls the visibility of the customers to ensure privacy of the customers.

Customer isolation enables the service provider to make changes to policies of one customer without affecting the other customers. The configuration of a policy at a customer in the customer hierarchy does not affect other customers that are not below it in the customer hierarchy. A change in the configuration of the policies only affects the customer on which they have been changed and the customers below it in the customer hierarchy.

The hierarchical service management system ensures that the private information of a TSP is protected and is visible only to it. Customer visibility enables each service provider to manage its customers without interference from the service providers that are above it in the customer hierarchy. The customer visibility is limited to one level so that each service provider can view the data of its immediate customers only. This allows a TSP to have its own customers without worrying about its immediate service provider coming to know about its customer details.

However, in case of an organization, where a higher level of visibility is required, the level of visibility can be varied to more than one. The policies also control the access rights of the customers. Some of the exemplary access rights are the right to create more customers, the right to create more rules, login rights to the system and the right to view rules.

The hierarchical service management system supports reporting in a hierarchical manner. The service providers and the customers can generate a report at any point of time to have information about the functioning of the service management system. A report contains monitoring data that helps in analyzing the enforcement of rules, security breaches, frequency of security breaches and other such issues. In case of an alarming situation, an alarm is generated to bring the situation to the notice of the customers and the immediate service provider.

In a preferred embodiment of the present invention the customer hierarchy is in the form of a tree.

In a customer hierarchy that is arranged in the form of a tree, a customer at the root of the customer hierarchy is called an RSP. A customer at the end of a branch in the customer hierarchy is called an end customer (EC). A customer neither at the root of the customer hierarchy nor at the end of a branch is called a TSP. An RSP can create zero or more TSPs and zero or more end customers under it. A TSP can also create zero or more TSPs and zero or more end customers under it. An end customer cannot create further customers. The RSP provides services to the TSPs and end customers that are its immediate customers. The TSPs under the RSP in turn provides services to their immediate customers.

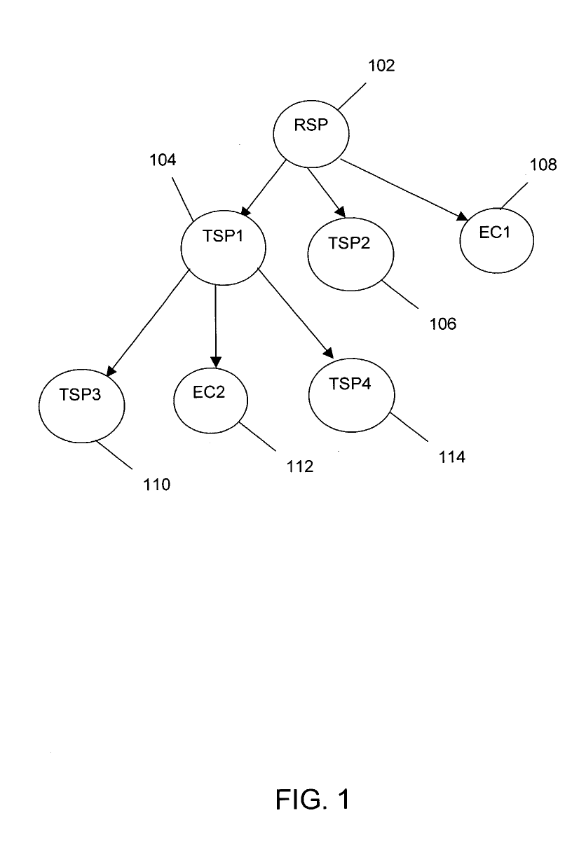

FIG. 1 shows a part of an exemplary customer hierarchy. An RSP 102 has a TSP1 104, a TSP2 106 and an EC1 108 as immediate customers. EC1 108 being an end customer of RSP 102 cannot have further customers, whereas TCP1 104 and TCP2 106 will have respective branches. TSP1 104 further has a TSP3 110, an EC2 112 and a TSP4 114 as immediate customers. EC2 112 is an end customer and cannot have any further customers. TSP3 110 and TSP4 114 can have further customers attached to them.

In a preferred embodiment of the present invention, a customer can join a place in the customer hierarchy based on an agreement with the immediate service provider. The immediate service provider can be an RSP or a TSP in the customer hierarchy. The customer can join as an end customer or a TSP. If the customer joins the hierarchy as a TSP, the customer can create further customers and need no approval from TSPs above it in the customer hierarchy or the RSP as long as it has resources.

It would be evident to one skilled in the art that there can be various other methods to decide the position of a customer in the customer hierarchy.

The RSP or the TSPs control their immediate customers by implementing policies and allocating resources to their immediate customers. In a preferred embodiment of the present invention, the policies are based on the agreement between the RSP or the TSPs and their immediate customers. The RSP or the TSPs also manage the resources of their immediate customers. The resources encompass all the aspects that a service provider wants to control. These aspects are called the attributes of the resource. Exemplary attributes can be the number of rules, the number of IP addresses and the bandwidth.

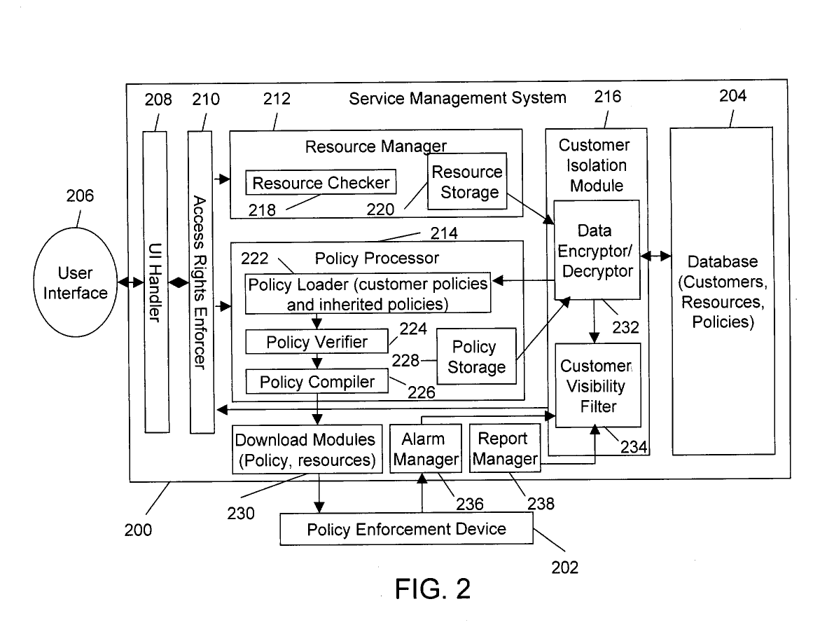

The policies in the customer hierarchy are implemented through a policy enforcement device. FIG. 2 is a block diagram of the hierarchical service management system with a user interface and the policy enforcement device, the user interface and the policy enforcement device being controlled by the hierarchical service management system.

The services to the customers are controlled by a policy enforcement device 202. Policy enforcement device 202 is controlled by a service management system 200. A customer in the customer hierarchy can access a database 204 containing the configuration data through a user interface 206. User interface 206 is associated with a user interface handler (UI handler) 208 that services all the requests received from user interface 206 and forwards the requests to an access rights enforcer 210.

Access rights enforcer 210 is responsible for enforcing the access rights in a hierarchical manner. The access rights of a customer are decided by the TSP above it in the customer hierarchy. By way of an example, in FIG. 1 RSP 102, being the root service provider, has unlimited access rights. The access right of RSP 102's immediate customers like TSP1 104, TSP2 106 and EC1 108 would be less than or equal to the access right of RSP 102. The access rights of TSP3 110, EC2 112 and TSP4 114 would be less than or equal to the access rights of TSP1 104 and so on. Also, a TSP cannot give an access right to its customer if the TSP itself does not have that access right.

Access rights enforcer 210 takes the requests from UI handler 208 and checks whether the customer has appropriate access rights to make the request. If the customer has insufficient access rights, then the request is not serviced and an error is sent to user interface 206. Else, the request is forwarded for processing.

Access right enforcer 208 is associated with a resource manager 212, a policy processor 214 and a customer isolation module 216.

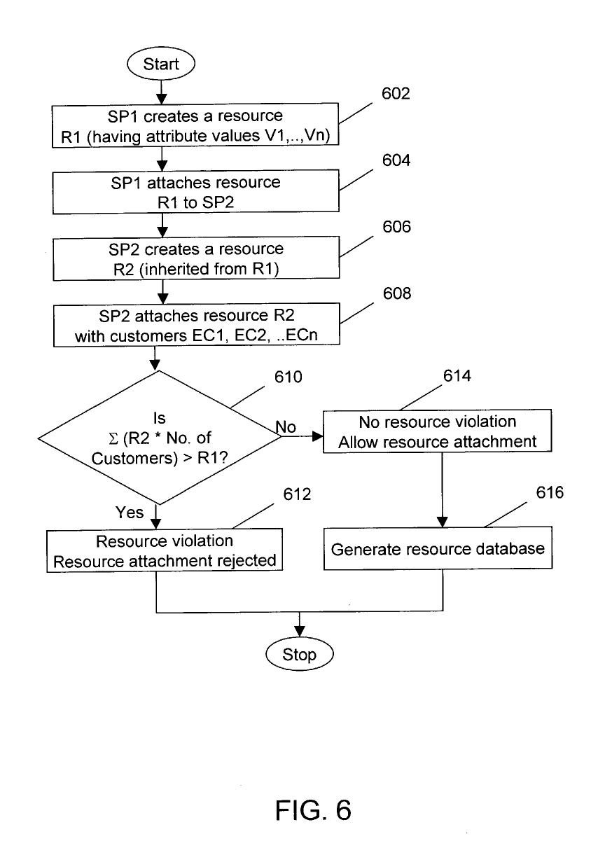

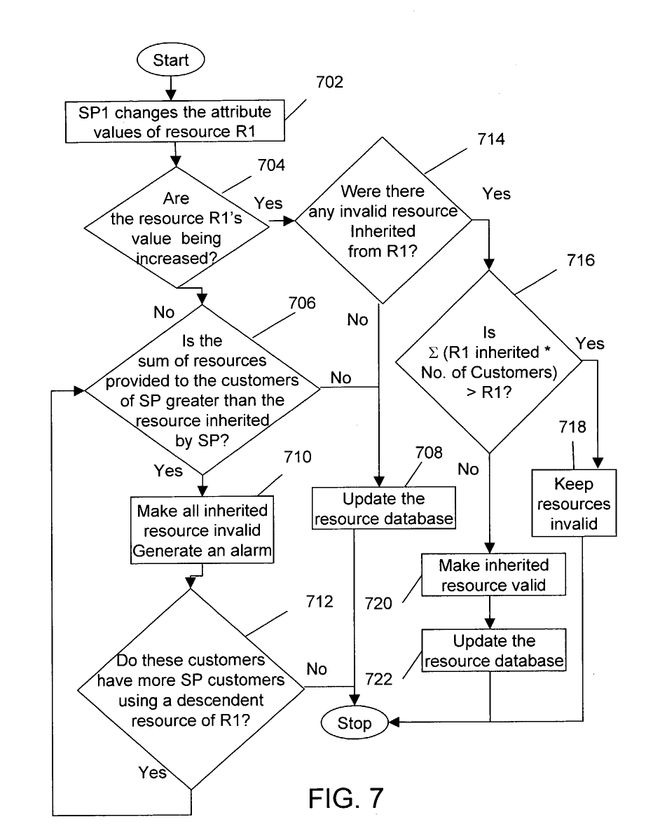

Resource manager 212 allocates resources to the customers. Resource manager 212 consists of a resource checker 218 and a resource storage 220. Resource checker 218 checks the validity of allocated resources to the customers. The method of validating the allocated resources is discussed further in FIG. 6 and FIG. 7. In case of a change in the allocated resources, the changed resources are stored in database 204 through customer isolation module 216.

Policy processor 214 is responsible for storage of policies, verification of policies and compilation of policies for policy enforcement device 202. Policy processor 214 consists of a policy loader 222, a policy verifier 224, a policy compiler 226 and a policy storage 228. Policy loader 222 is responsible for loading all the policies from database 204. For a customer, it loads all the rules assigned to that customer by its service provider and also all the inherited rules from the service providers above it in the customer hierarchy up to the RSP. Policy loader 222 then passes on the loaded policies to policy verifier 224. Policy verifier 224 checks the validity of all the rules. If a rule of the customer is violating any of the non-overridable rules inherited from the service providers above the customer in the customer hierarchy, then the rule is given a lower priority than the non-overridable rule. After verification, policy verifier 224 passes the rules to policy compiler 226. Policy compiler 226 is responsible for compiling the rules and generating the output in a format that is understandable by policy enforcement device 202. The output of policy compiler 226 is given to a download module 230. Download module 230 downloads the policies and resources on policy enforcement device 202. Policy storage 230 is responsible for storage of policies in database 204 through data encryptor/decryptor module 232.

Customer isolation module 216 is responsible for determining that a customer cannot view or modify the data of its peer customer. Also customer isolation module 216 makes sure that only appropriate levels of customers are visible to a service provider. When a customer joins the hierarchy, then access rights of the customer are decided by the service provider above it. These access rights provide customer isolation using customer isolation module 216. Customer isolation module 216 consists of data encryptor/decryptor module 232 and a customer visibility filter 234. Data encryptor/decryptor module 232 encrypts the data of the customers before storing it on to database 204. Exemplary data can be customer information, policy and resource assignments. Data encryptor/decryptor module 232 ensures by encryption that even the RSP, having full access to database 204, cannot view the data of all the customers. This ascertains customer isolation. In a preferred embodiment, the RSP and the TSPs are able to see the data of their immediate customers only. By way of an example, in FIG. 1, TSP3 110, EC2 112 and TSP4 114 are immediate customers of TSP1 104, whereas TSP2 106 is not an immediate customer. TSP1 104 and TSP2 106 are immediate customers of RSP 102. TSP1 104 would be able to see configuration data of TSP3 110, EC2 112 and TSP4 114 but not of TSP 106. Also, RSP 102 would not be able to see configuration data of TSP3 110, EC2 112 and TSP4 114, as they are not RSP 102's immediate customers. Customer visibility is restricted by the settings of customer visibility filter 234 and is based on the contract between the RSP and the TSPs. Further, in case of an organization where higher level of visibility is required, the customer visibility can be varied from one level to multiple levels by changing the parameters of customer visibility filter 234. In a preferred embodiment, the customer visibility is fixed at the time of setting up the hierarchy. Similarly, data encryptor/decryptor module 232 decrypts the data before it is processed by other modules, such as resource manager 212 or policy processor 214, or before the data is forwarded to user interface 206. Customer visibility filter 234 makes sure that a customer in the customer hierarchy is able to view only the data to which the customer has access rights. All the information that is sent to user interface 206 must pass through customer visibility filter 234. The information may be data in response to a request from user interface 206 or some other data that is generated by the service management system such as an alarm.

An alarm manager 236 receives alarms from policy enforcement device 202. Alarm manager 236 stores the alarm in database 204, processes the alarm for monitoring purposes and then passes it to customer visibility filter 234. Customer visibility filter 234 figures out which customer the alarm belongs to and then sends the alarm to the customer and its immediate service provider.

A report manager 238 is responsible for generating various reports for data collected from policy enforcement device 202 to monitor various conditions. A report is generated using the monitoring data that is generated to check the conditions of the service management system. The report generated can be used by the customer or the customer's immediate service provider to analyze the enforcement of rules, security breaches, frequency of security breaches and other such conditions. Report manager 238 sends the generated reports to appropriate customers through customer visibility filter 234.

The customer can generate the report containing data about itself and its immediate customers in an aggregated manner. By way of an example, in FIG. 1, RSP 102 generates a report. The report will have data about RSP 102 and the customers, TSP1 104, TSP2 106 and EC1 108 in a cumulative manner. RSP 102 will not be able to distinguish between the data of TSP3 110, EC2 112 and TSP4 114. The data of TSP3 110, EC2 112 and TSP4 114 will be aggregated as TSP1 104 data when RSP 102 generates the report.

The policies are enforced in a hierarchical manner. A customer can create more rules within its policy as long as the rules do not conflict with the rules given by the RSP. The rules enforced by the RSP or the TSP in the customer hierarchy can be overridable rules or non-overridable rules. Overridable rules are the rules that can be overridden by the customers. The advantage of these rules is that the RSP or the TSP in the customer hierarchy can give a common set of widely known rules to the customers below them in the customer hierarchy and the customers can change them if required. Non-overridable rules are rules that take priority over the rules defined by the customers. If a customer defines a rule, it is given lower priority than the non-overridable rules and higher priority than the overridable rules defined by the service providers above it. If the flow of network traffic matches multiple rules, the one with highest priority is enforced. Hence if the flow of network traffic matches a non-overridable rule as well as the customer rule, the non-overridable rule is enforced for the flow since it has higher priority than the customer rule.

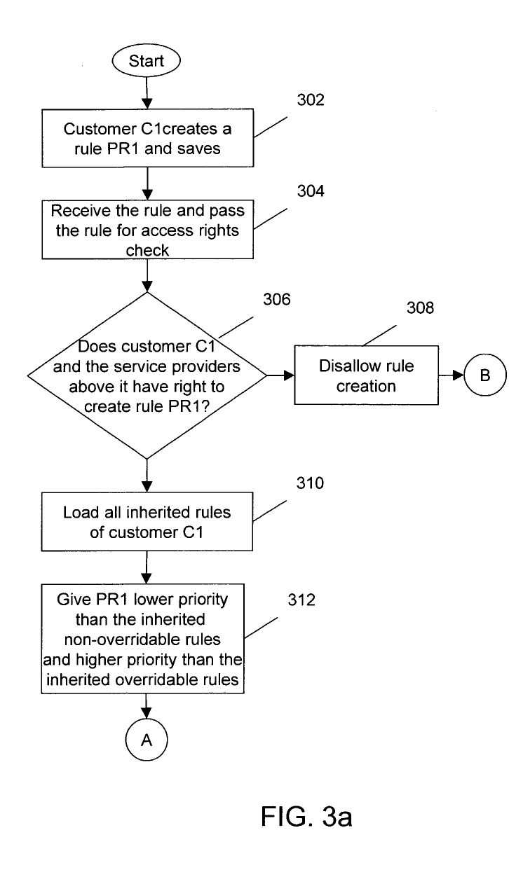

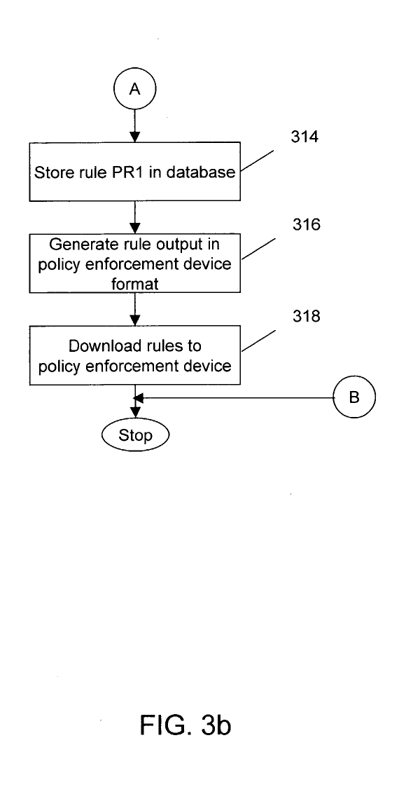

FIGS. 3a and 3b shows a flowchart illustrating a rule creation in the hierarchical service management system by a customer.

At step 302, a customer C1 creates a rule PR1 and saves it through user interface 206. The customer C1 can be an RSP, a TSP or an end customer.

At step 304, the rule is received by UI handler 208 and is passed for access rights check to access right enforcer 210.

At step 306, access rights enforcer 210 determines whether the customer C1 and the service providers above it in the customer hierarchy have the right to create the rule PR1.

If the customer C1 or any of the customers above it in the customer hierarchy does not have the right to create the rule PR1, then the rule is discarded at step 308 and thus, the customer's attempt to create the rule fails. Else, if the customer C1 and all the customers above it in the customer hierarchy have the right to create the rule PR1, then all rules inherited by the customer C1 from the service providers above it in the customer hierarchy are loaded on policy loader 222 from database 204 at step 310. The rules are stored in an encrypted form in database 204. So the rules are decrypted by data decryptor 216 and then loaded on policy loader 222.

At step 312, the rule PR1 is given a priority in comparison to the inherited rules by policy verifier 224. The rule PR1 is given a lower priority than the inherited non-overridable rules and a higher priority than the inherited overridable rules. The rules that have a higher priority are given a preference over the rules that have a lower priority in the rule match for enforcement by policy enforcement device 202. Once the flow of network traffic matches a rule out of the rules to be enforced on the network traffic, further rules are not matched. By way of an example, if the flow of network traffic matches with a non-overridable rule and PR1, non-overridable rule will be effective for the data-flow since it has a higher priority.

At step 314, the rule PR1 is stored in database 204 through data encryptor 216 by policy storage 228. The data is encrypted in a format that ensures customer isolation.

At step 316, policy compiler 226 generates the rules in a format compatible to be downloaded to policy enforcement device 202.

At step 318, the rules are downloaded to policy enforcement device 202 by download module 230 to be implemented on the customer C1 and the customers below the customer C1 in the customer hierarchy.

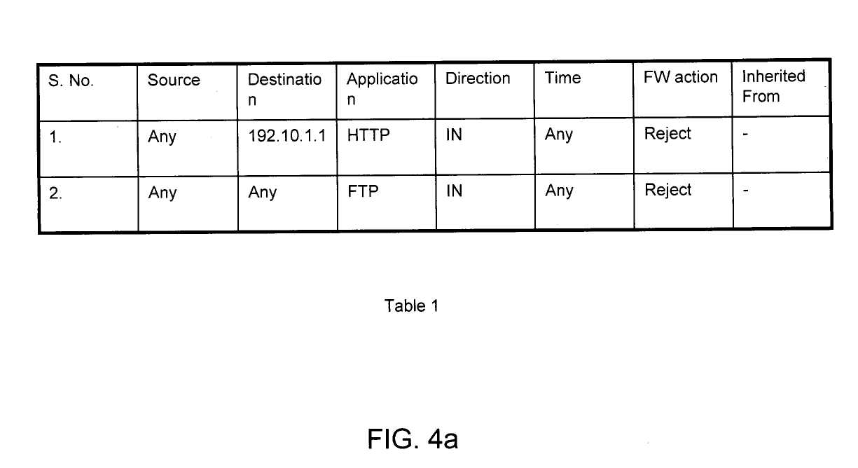

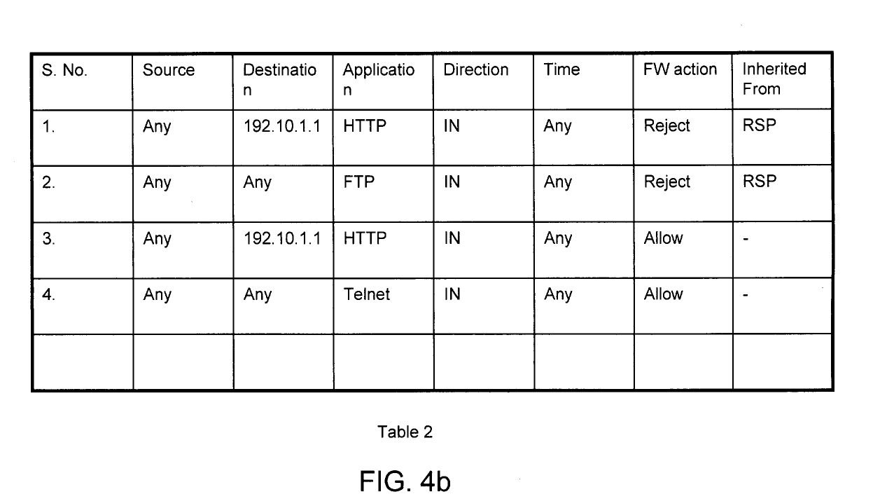

FIGS. 4a and 4b show tables depicting the policies enforced in a hierarchical manner. Table 1 shows the rules created by RSP 102 for EC1 108 and table 2 shows the rules for EC1 108. Rows of the tables represent rules and the columns represent information relating to the rules. The “source” and “destination” columns of tables 1 and 2 denote the source and destination Internet Protocol (IP) addresses relating to the network traffic. The “application” column denotes the type of application, the “direction” column denotes the direction of network traffic flow, and the “time” column denotes the time for which the rule is applicable. The “FW action” column denotes the firewall action relating to the rule and the “inherited from” column denotes the service provider from which the rule has been inherited. In table 2, rules 3 and 4 are the rules added by EC1 108 to the rules made by RSP 102. Rule 1 will not be effective as it contradicts with the rule 1 given by RSP 102 and is a lower priority rule. Rule 4 will become effective, as it does not conflict with any rules given by RSP 102 and hence network traffic on which this rule will be enforced will have rule 4 as the highest priority matched rule.

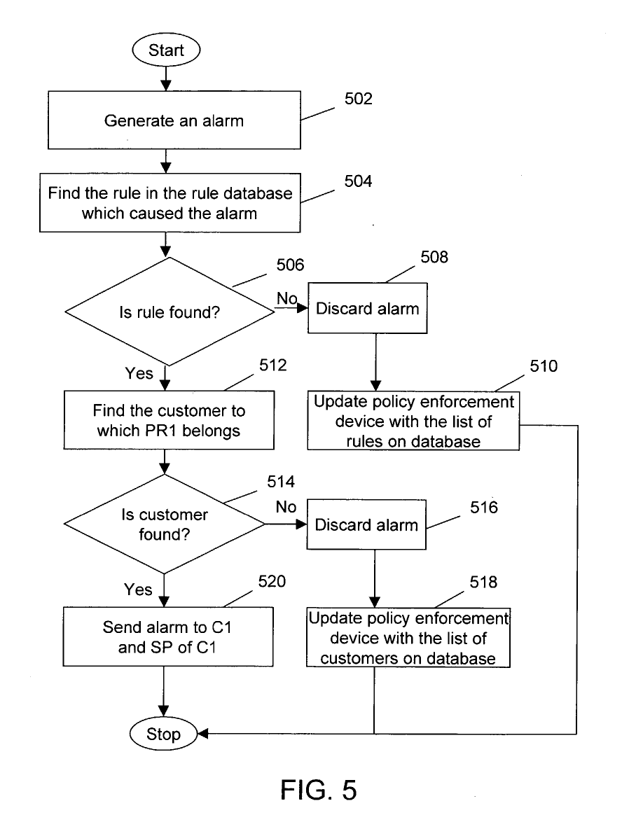

To detect an alarming condition in the network, policy enforcement device 202 generates an alarm when the flow of network traffic matches a predefined rule. The alarm generation when the flow of network traffic matches a predefined rule can be used to detect situations like security breach in the system. FIG. 5 is a flowchart illustrating the functioning of an alarm when the flow of network traffic matches with a predefined rule.

At step 502, policy enforcement device 202 generates an alarm due to network traffic matching with a predefined rule as provided by a service provider having access rights to create such a rule.

At step 504, alarm manager 236 does a search for the rule that generated the alarm in policy enforcement device 202.

At step 506, it is determined whether the rule exists or not. If the rule is not found in database 204, it represents an error and the alarm is discarded at step 508.

At step 510, the list of rules is updated on policy enforcement device 202, as there is mismatch between the rules in service management system 200 and policy enforcement device 202.

At step 512, if the rule is found in the list of rules on policy enforcement device 202, then the customer to whom the rule belonged is searched in the list of customers on policy enforcement device 202.

At step 514, alarm manager 236 determines whether the customer exists or not. If the customer is not found, it represents an error and the alarm is discarded at step 516.

At step 518, the list of customers is updated on policy enforcement device 202, as there is mismatch between the rules in service management system 200 and policy enforcement device 202.

At step 520, if the customer is found in the list of customers on policy enforcement device 202, then the alarm is sent to the customer and the customer's service provider informing about the rule match through customer visibility filter 234.

An alarm is also generated if there is a resource violation at the time of configuration of the resources.

The resources for the customers are controlled by the customer's immediate service provider. The resources are hierarchically distributed and the sum of the resources distributed to the customers by the service provider should not exceed the resources received by the service provider. By way of an example, in FIG. 1 the sum of resources distributed by TSP1 104 to TSP3 110, EC2 112 and TSP4 114 should not exceed the resource allocated to TSP1 104 by RSP 102.

FIG. 6 is a flowchart illustrating the resource allocation to the customers.

At step 602, a service provider SP1 creates a resource R1 having attributes V1, V2, . . . , Vn through user interface 206.

The service provider SP1 attaches the resource R1 to its immediate customer SP2 at step 604 through resource manager 212.

At step 606, the service provider SP2 creates a resource R2, inherited from the resource R1.

At step 608, the service provider attaches the resource R2 to its immediate customers EC1, EC2, . . . , ECn.

At step 610, resource checker 218 checks to determine whether the sum of the resources distributed by the service provider SP2 to its immediate customers is greater than the resource R1 allocated to the service provider SP2 by the service provider SP1. When checking for the resources, each attribute value of the resource is checked:

$$\begin{matrix}\sum V1 [ R2 ] * No . of customers > \sum V1 [ R1 ] AND \\ \sum V2 [ R2 ] * No . of customers > \sum V2 [ R1 ] AND \\ ⋮ \\ \sum Vn [ R2 ] * No . of customers > \sum Vn [ R1 ]\end{matrix}$$

At step 612, if the sum of resources distributed by the service provider SP2 to its immediate customers is greater than the resource allocated to the service provider SP2 by the service provider SP1, then the resource attachment to the customers of the service provider SP2 is rejected. Else, if the sum of resources distributed by the service provider SP2 to its immediate customers is less than or equal to the resource allocated to the service provider SP2 by the service provider SP1, then the resource attachment to the end customer EC1 is allowed at step 614.

At step 616, resource storage 220 generates the resource list on database 204 for the end customer EC1.

The resources allocated to the customers can be changed by the service provider as and when required. FIG. 7 shows a flowchart illustrating the change in the allocated resources to the customers.

At step 702, a service provider SP1 changes the attribute values of a resource R1 that it has attached to one or more of its immediate customers.

At step 704, resource manager 212 determines whether the resource R1 has been increased or not. If the resource R1's value has not been increased, then it is determined by resource checker 218 whether the sum of resources distributed to the customers of a service provider SP who is a customer of SP1 is greater than the value of the resource R1 at step 706.

If the sum of the resources is not greater than the value of the resource R1, then the resource list on database 204 is updated at step 708. Else, if the sum of the resources is greater than the value of the resource R1, the inherited resources of the resource R1 are made invalid at step 710 and an alarm is generated. At step 712, it is then determined whether the customers of the service provider SP have further customers that are using an inherited resource of the resource R1. If so, then the steps 706, 708, 710 and 712 are repeated for them.

Referring back to step 704, if there is a change in the value of the resource R1, then resource checker 218 determines whether there were any previously invalid resources inherited from the resource R1 at step 714. If there were no invalid resources inherited from the resource R1, then the resource list on database 204 is updated at step 708. Else, resource checker 218 determines whether the sum of the resources distributed to the customers is greater than the value of the resource R1 at step 716.

If the sum of the resources distributed to the customers is greater than the value of the resource R1, the resources are kept invalid at step 718 and an alarm is generated. Else, the inherited resource of the resource R1 is made valid at step 720.

Subsequently, the list of resources on database 204 is updated at step 722.

The system, as described in the present invention or any of its components may be embodied in the form of a processing machine. Typical examples of a processing machine include a general-purpose computer, a programmed microprocessor, a micro-controller, a peripheral integrated circuit element, and other devices or arrangements of devices that are capable of implementing the steps that constitute the method of the present invention.

The processing machine executes a set of instructions that are stored in one or more storage elements, in order to process input data. The storage elements may also hold data or other information as desired. The storage element may be in the form of a database or a physical memory element present in the processing machine.

The set of instructions may include various instructions that instruct the processing machine to perform specific tasks such as the steps that constitute the method of the present invention. The set of instructions may be in the form of a program or software. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine.

A person skilled in the art can appreciate that it is not necessary that the various processing machines and/or storage elements be physically located in the same geographical location. The processing machines and/or storage elements may be located in geographically distinct locations and connected to each other to enable communication. Various communication technologies may be used to enable communication between the processing machines and/or storage elements. Such technologies include session of the processing machines and/or storage elements, in the form of a network. The network can be an intranet, an extranet, the Internet or any client server models that enable communication. Such communication technologies may use various protocols such as TCP/IP, UDP, ATM or OSI.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A method for managing one or more customers of a Root Service Provider (RSP) in a hierarchical manner, the method comprising the steps of:
a. creating a hierarchy of customers under the RSP, the customers comprising one or more Tiered Service Providers (TSPs) and one or more end customers;
b. allocating one or more resources to each of the TSPs and each of the end customers, the allocation being done by the RSP, the allocation being done for the immediate customers, each of the TSPs further allocating resources to the TSPs and the end customers under them;
c. implementing one or more policies on each of the TSPs and each of the end customers by the RSP, the implementation being done on the immediate customers, the TSPs further implementing the policies on the TSPs and the end customers under them, the policy being a set of rules;
d. determining a resource violation for each of the customers; and
e. determining a rule match of the flow of network traffic to a predefined rule belonging to one or more of the customers wherein the predefined rule is defined by the customer or the TSPs or the RSP above the customer in the customer hierarchy.

2. The method as recited in claim 1 wherein the method further comprises generating a report in a predefined format, the report being generated by a customer in the customer hierarchy.

3. The method as recited in claim 1 wherein the TSPs can further create one or more TSPs and one or more end customers under them.

4. The method as recited in claim 1 wherein the step of determining resource violation for each of the TSPs and each of the end customers comprises:
a. checking for a resource violation, the check being done on each of the TSPs and each of the end customers;
b. generating an alarm if there is a resource violation by a customer; and
c. propagating the alarm to the customer and the customer's service provider.

5. The method as recited in claim 1 wherein the step of determining the rule match of the flow of network traffic comprises:
a. checking for a rule match of the flow of network traffic to a predefined rule belonging to one or more of the customers, the check being done on each of the TSPs and each of the end customers;
b. generating an alarm if there is a rule match for a customer; and
c. propagating the alarm to the customer and the customer's service provider.

6. The method as recited in claim 1 wherein the step of creating the customer hierarchy under the RSP is done based on an agreement between each of the customers and the immediate TSP or the RSP.

7. The method as recited in claim 1 wherein the step of creating the customer hierarchy under the RSP comprises the step of providing customer isolation.

8. The method as recited in claim 1 wherein the step of creating the customer hierarchy under the RSP comprises the step of providing a pre-defined customer visibility.

9. The method as recited in claim 1 wherein the step of implementing policies on the TSPs and the end customers is done in a predefined hierarchical manner.

10. The method as recited in claim 1 wherein the step of allocating resources to the TSPs and the end customers is such that the resources are hierarchically distributed.

11. The method as recited in claim 9 wherein the policies are inherited by the customers down in the customer hierarchy.

12. The method as recited in claim 9 wherein the rules in the policy comprise overridable rules and nonoverridable rules.

13. A service management system for managing one or more customers of a Root Service Provider (RSP) in a hierarchical manner, the customers being Tiered Service Providers (TSPs) and end customers, the system comprising:
a. a resource manager for allocating one or more resources to each of the TSPs and each of the end customers, the allocation being done for the immediate customers, each of the TSPs further allocating resources to the TSPs and the end customers under them;
b. a policy enforcement device for implementing one or more policies on each of the TSPs and each of the end customers, the implementation being done on the immediate customers, the TSPs further implementing the policies on the TSPs and the end customers under them, the policy being a set of rules, the policy enforcement device detecting a resource violation by a customer, the policy enforcement device detecting a rule match of the flow of network traffic with a predefined rule belonging to one or more of the customers wherein the predefined rule is defined by the customer or the TSPs or the RSP above the customer in the customer hierarchy; and
c. an alarm manager for triggering an alarm if there is a resource violation or a rule match, the alarm being sent to the customer and the customer's immediate service provider.

14. The system as recited in claim 13 wherein the system further comprises a policy processor for creating rules and loading the rules to the policy enforcement device.

15. The system as recited in claim 13 wherein the system further comprises a report manager for generating a report in a predefined format, the report being generated by a customer in the customer hierarchy.

16. A computer program product for use with a computer, the computer program product comprising a computer usable medium having a computer readable program code embodied therein for managing one or more customers of a Root Service Provider (RSP) in a hierarchical manner, the customers being Tiered Service Providers (TSPs) and end customers, the computer program code performing the steps of:
a. allocating one or more resources to each of the TSPs and each of the end customers, the allocation being done by the RSP, the allocation being done for the immediate customers, each of the TSPs further allocating resources to the TSPs and the end customers under them;
b. implementing one or more policies on each of the TSPs and each of the end customers by the RSP, the implementation being done on the immediate customers, the TSPs further implementing the policies on the TSPs and the end customers under them, the policy being a set of rules;
c. determining a resource violation for each of the customers; and
d. determining a rule match of the flow of network traffic with a predefined rule belonging to one or more of the customers wherein the predefined rule is defined by the customer or the TSPs or the RSP above the customer in the customer hierarchy.

17. The computer program product as recited in claim 16 wherein the computer program code further performs the step of generating a report in a predefined format, the report being generated by a customer in the customer hierarchy.

18. A method for managing one or more customers of a Root Service Provider (RSP) in a hierarchical manner, the method comprising the steps of:
a. creating a customer hierarchy under the RSP, the customer hierarchy comprising one or more Tiered Service Providers (TSPs) and one or more end customers;
b. allocating one or more resources to each of the TSPs and each of the end customers, the allocation being done by the RSP, the allocation being done for the immediate customers, the TSPs further allocating resources to the TSPs and the end customers under them;
c. implementing policies on each of the TSPs and each of the end customers by the RSP, the implementation being done on the immediate customers, the TSPs further implementing policies on the TSPs and the end customers under them, the policy being a set of rules;
d. determining a resource violation for the customers wherein the step of determining comprises:
i. checking for a resource violation by each of the TSPs and each of the end customers;
ii. generating an alarm if there is a resource violation by a customer; and
iii. propagating the alarm to the customer and the customer's service provider; and
e. determining a rule match of the flow of network traffic with a predefined rule wherein the step of determining comprises:
i. checking the flow of network traffic for a rule match with a predefined rule belonging to one or more of the customers wherein the predefined rule is defined by the customer or the TSPs or the RSP above the customer in the customer hierarchy;
ii. generating an alarm if a rule match is found; and
iii. propagating the alarm to the customer and the customer's service provider.

19. A service management system for managing one or more customers of a Root Service Provider (RSP) in a hierarchical manner, the customers being Tiered Service Providers (TSPs) and end customers, the system comprising:
a. a resource manager for allocating one or more resources to each of the TSPs and each of the end customers, the allocation being done for the immediate customers, each of the TSPs further allocating resources to the TSPs and the end customers under them;
b. a policy enforcement device for implementing one or more policies on each of the TSPs and each of the end customers, the implementation being done on the immediate customers, the TSPs further implementing the policies on the TSPs and the end customers under them, the policy being a set of rules, the policy enforcement device detecting a resource violation by a customer, the policy enforcement device detecting a rule match of the flow of network traffic with a predefined rule belonging to one or more of the customers wherein the predefined rule is defined by the customer or the TSPs or the RSP above the customer in the customer hierarchy;
c. a policy processor for creating rules and loading the rules to the policy enforcement device by a customer;
d. an alarm manager for triggering an alarm if there is a resource violation or a rule match, the alarm being sent to the customer and the customer's immediate service provider; and
e. a report manager for generating a report in a predefined format, the report being generated by a customer in the customer hierarchy.
